(19) United States
(12) Patent Application Publication
(10) Pub. No.: US 2024/0291547 A1
(43) Pub. Date: Aug. 29, 2024

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP)

(73) Assignee: NTT DOCOMO, INC., Tokyo (JP)

(21) Appl. No.: 18/568,146

(22) PCT Filed: Jun. 11, 2021
(86) PCT No.: PCT/JP2021/022381

§ 371 Date: Dec. 7, 2023

(51) Int. Cl. H04B 7/06; H04L 5/00; H04W 72/21

(52) U.S. Cl. CPC H04B 7/06964; H04L 5/0035; H04W 72/21

(57) ABSTRACT

A terminal according to one aspect of the present disclosure includes: a transmitting section that transmits, when beam failure is detected in a transmission/reception point (TRP), a scheduling request by using another uplink control channel resource different from an uplink control channel resource associated with the TRP; and a control section that performs control to update the uplink control channel resource associated with the TRP after a recovery procedure for the beam failure.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+(plus),” “6th generation mobile communication system (6G),” “New Radio (NR),” “3GPP Rel. 15 (or later versions),” and so on) are also under study.

In existing LTE systems (LTE Rel. 8 to Rel. 15), monitoring of radio link quality (radio link monitoring (RLM)) is performed. When radio link failure (RLF) is detected as a result of the RLM, a request of re-establishment of RRC (Radio Resource Control) connection is made to a user terminal (User Equipment (UE)).

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (for example, NR), it is studied to perform a procedure for detecting beam failure and switching to another beam (which may be referred to as a beam failure recovery (BFR) procedure, BFR, link recovery procedures, and the like).

In NR of Rel. 17 or later versions (or Beyond 5G, 6G, or later versions), it is also assumed that a terminal performs communication by using a plurality of transmission/reception points (TRPs)/UE panels. In this case, it is conceivable that beam management (for example, beam failure detection) is performed in the plurality of TRPs/plurality of UE panels, and there arises a problem of how to control beam failure detection (BFD) or beam failure recovery (BFR) in each TRP/UE panel. Unless beam failure detection or beam failure recovery in each TRP/UE panel is appropriately controlled, communication throughput may decrease, or communication quality may deteriorate.

The present disclosure has been made in view of this respect, and an object of the present disclosure is to provide a terminal, a radio communication method, and a base station with which beam failure detection or beam failure recovery can be appropriately performed even when a plurality of transmission/reception points are used.

### Solution to Problem

A terminal according to one aspect of the present disclosure includes: a transmitting section that transmits, when beam failure is detected in a transmission/reception point (TRP), a scheduling request by using another uplink control channel resource different from an uplink control channel resource associated with the TRP; and a control section that performs control to update the uplink control channel resource associated with the TRP after a recovery procedure for the beam failure.

### Advantageous Effects of Invention

According to one aspect of the present disclosure, beam failure detection or beam failure recovery can be appropriately performed even when a plurality of transmission/reception points are used.

### BRIEF DESCRIPTION OF DRAWINGS

FIG. 1 is a diagram to show an example of a beam recovery procedure in Rel-15 NR.

FIG. 2A to FIG. 2C are diagrams to show examples of configuration of a PUCCH resource for a scheduling request and a spatial relation (s).

FIG. 3 is a diagram to show an example of configuration of a BFD-RS set.

FIG. 4 is a diagram to show an example of a BFR procedure according to a second aspect.

FIG. 5A and FIG. 5B are diagrams to show other examples of the BFR procedure according to the second aspect.

FIG. 6 is a diagram to show an example of associations between a PUCCH resource for SR and a TRP according to a third aspect.

FIG. 7A and FIG. 7B are diagrams to show examples of a BFR procedure according to a fourth aspect.

FIG. 8 is a diagram to show another example (case 4-1) of the BFR procedure according to the fourth aspect.

FIG. 9 is a diagram to show another example (case 4-2) of the BFR procedure according to the fourth aspect.

FIG. 10 is a diagram to show another example (case 4-3) of the BFR procedure according to the fourth aspect.

FIG. 11 is a diagram to show another example (case 4-1′) of the BFR procedure according to the fourth aspect.

FIG. 12 is a diagram to show another example (case 4-2′) of the BFR procedure according to the fourth aspect.

FIG. 13 is a diagram to show another example (case 4-3′) of the BFR procedure according to the fourth aspect.

FIG. 14 is a diagram to show an example of a schematic structure of a radio communication system according to one embodiment.

FIG. 15 is a diagram to show an example of a structure of a base station according to one embodiment.

FIG. 16 is a diagram to show an example of a structure of a user terminal according to one embodiment.

FIG. 17 is a diagram to show an example of a hardware structure of the base station and the user terminal according to one embodiment.

### DESCRIPTION OF EMBODIMENTS

### (Beam Failure Detection)

In NR, communication is performed by using beam forming. For example, a UE and a base station (for example, gNB (gNodeB)) may use a beam used for signal transmission (also referred to as a transmit beam, Tx beam, and the like) and a beam used for signal reception (also referred to as a receive beam, Rx beam, and the like).

Using the beam forming is susceptible to interference from an obstruction, and thus it is assumed that radio link quality deteriorates. Due to deterioration of the radio link quality, radio link failure (RLF) may occur frequently. Occurrence of the RLF requires reconnection of a cell, and thus frequent occurrence of the RLF causes deterioration of system throughput.

In NR, in order to suppress occurrence of the RLF, a procedure for switching to another beam (which may be referred to as beam recovery (BR), beam failure recovery (BFR), L1/L2 (Layer 1/Layer 2) beam recovery, and the like) is performed in a case where quality of a specific beam deteriorates. Note that the BFR procedure may be simply referred to as BFR.

Note that beam failure (BF) in the present disclosure may be referred to as link failure.

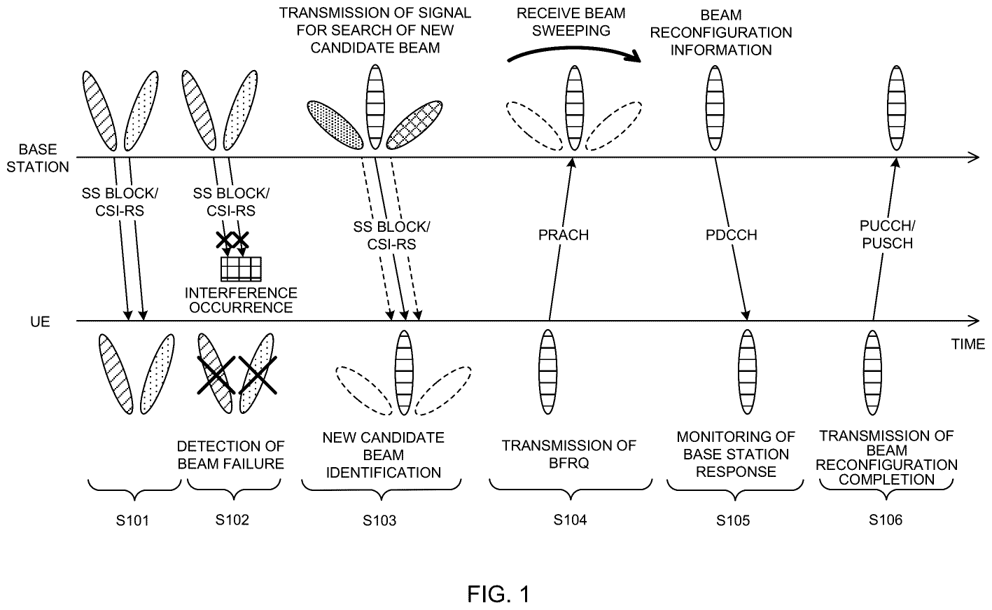

FIG. 1 is a diagram to show an example of a beam recovery procedure in Rel-15 NR. The number of beams and the like are just examples, and are not limited to these. In an initial state (step S101) of FIG. 1, the UE performs measurement based on a reference signal (RS) resource transmitted by using two beams.

The RS may be at least one of a synchronization signal block (SSB) and an RS for channel state measurement (Channel State Information RS (CSI-RS)). Note that the SSB may be referred to as an SS/PBCH (Physical Broadcast Channel) block and the like.

The RS may be at least one of a primary synchronization signal (Primary SS (PSS)), a secondary synchronization signal (Secondary SS (SSS)), a mobility reference signal (Mobility RS (MRS)), a signal included in the SSB, the SSB, the CSI-RS, a demodulation reference signal (DMRS), a beam-specific signal, and the like, or may be a signal constituted by expanding, changing, or the like these signals. The RS measured at step S101 may be referred to as an RS for beam failure detection (Beam Failure Detection RS (BFD-RS), SR for beam failure detection), an RS to be used for a beam recovery procedure (BFR-RS), or the like.

At step S102, due to interference of radio waves from the base station, the UE fails to detect the BFD-RS (or reception quality of the RS deteriorates). Such interference may occur due to an influence of an obstacle, fading, interference, or the like between the UE and the base station, for example.

The UE detects beam failure when a given condition is satisfied. For example, the UE may detect occurrence of the beam failure when a BLER (Block Error Rate) with respect to all of configured BFD-RSs (BFD-RS resource configurations) is less than a threshold. When occurrence of the beam failure is detected, a lower layer (physical (PHY) layer) of the UE may notify (indicate) a higher layer (MAC layer) of a beam failure instance.

Note that a judgment standard (criterion) is not limited to the BLER and may be reference signal received power in the physical layer (Layer 1 Reference Signal Received Power (L1-RSRP)). The beam failure detection may be performed based on a downlink control channel (Physical Downlink Control Channel (PDCCH)) instead of the RS measurement or in addition to the RS measurement. The BFD-RS may be expected to be quasi-co-located (QCLed) with a DMRS for a PDCCH monitored by the UE.

Here, QCL is an indicator indicating statistical properties of the channel. For example, when a given signal/channel and another signal/channel are in a relationship of QCL, it may mean that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

Information related to the BFD-RS (for example, indices, resources, numbers, the number of ports, precoding, and the like for the RS), information related to the beam failure detection (BFD) (for example, the above-mentioned threshold), and the like may be configured (notified) for the UE by using higher layer signaling or the like. The information related to the BFD-RS may be referred to as information related to resources for BFR and the like.

In the present disclosure, the higher layer signaling may be, for example, any one or combinations of RRC (Radio Resource Control) signaling, MAC (Medium Access Control) signaling, broadcast information, and the like.

For example, the MAC signaling may use media access control control elements (MAC CEs), MAC PDUs (Protocol Data Units), and the like. The broadcast information may be, for example, a master information block (MIB), a system information block (SIB), minimum system information (Remaining Minimum System Information (RMSI)), other system information (OSI), or the like.

A higher layer of the UE (for example, the MAC layer) may start a given timer (which may be referred to as a beam failure detection timer) when receiving beam failure instance notification from the PHY layer of the UE. The MAC layer of the UE may trigger BFR (for example, start any one of random access procedures mentioned below) when receiving the beam failure instance notification given times (for example, beamFailureInstanceMaxCount configured by RRC) or more until the timer expires.

When there is no notification from the UE or when the base station receives a given signal (beam recovery request at step S104) from the UE, the base station may judge that the UE has detected beam failure.

At step S103, for beam recovery, the UE starts a search for a new candidate beam for use in new communication. The UE may select, by measuring a given RS, the new candidate beam corresponding to the RS. The RS measured at step S103 may be referred to as a new candidate RS, an RS for new candidate beam identification (New Candidate Beam Identification RS (NCBI-RS)), a CBI-RS, a CB-RS (Candidate Beam RS), or the like. The NCBI-RS may be the same as the BFD-RS, or may be different from the BED-RS. Note that the new candidate beam may be simply referred to as a candidate beam or a candidate RS.

The UE may determine a beam corresponding to an RS satisfying a given condition as the new candidate beam. The UE may determine a new candidate beam, based on an RS having an L1-RSRP exceeding a threshold among configured NCBI-RSs, for example. Note that a judgment standard (criterion) is not limited to the L1-RSRP. The L1-RSRP related to an SSB may be referred to as SS-RSRP. The L1-RSRP related to a CSI-RS may be referred to as CSI-RSRP.

Information related to the NCBI-RS (for example, resources, numbers, the number of ports, precoding, and the like for the RS), information related to new candidate beam identification (NCBI) (for example, the above-mentioned threshold value), and the like may be configured (notified) for the UE by using higher layer signaling or the like. The information related to the new candidate RS (or NCBI-RS) may be acquired based on information related to the BFD-RS. The information related to the NCBI-RS may be referred to as information related to resources for NBCI and the like.

Note that the BFD-RS, the NCBI-RS, and the like may be interpreted as a radio link monitoring reference signal (Radio Link Monitoring RS (RLM-RS)).

At step S104, the UE that has identified the new candidate beam transmits a beam recovery request (Beam Failure Recovery reQuest (BFRQ)). The beam recovery request may be referred to as a beam recovery request signal, a beam failure recovery request signal, and the like.

The BFRQ may be transmitted by using at least one of an uplink control channel (Physical Uplink Control Channel (PUCCH)), a random access channel (Physical Random Access Channel (PRACH)), an uplink shared channel (Physical Uplink Shared Channel (PUSCH)), and a configured grant (CG) PUSCH, for example.

The BFRQ may include information about the new candidate beam/new candidate RS identified at step S103. Resources for the BFRQ may be associated with the new candidate beam. The information about the beam may be notified by using a beam index (BI), a port index of a given reference signal, an RS index, a resource index (for example, a CSI-RS resource indicator (CRI)), an SSB resource indicator (SSBRI), or the like.

For Rel-15 NR, CB-BFR (Contention-Based BFR) that is BFR based on a contention-based random access (RA) procedure and CF-BFR (Contention-Free BFR) that is BFR based on a non-contention based random access procedure are studied. In the CB-BFR and the CF-BFR, the UE may transmit a preamble (also referred to as an RA preamble, a random access channel (Physical Random Access Channel (PRACH)), a RACH preamble, and the like) as the BFRQ by using PRACH resources.

In the CB-BFR, the UE may transmit a preamble randomly selected from one or a plurality of preambles. In contrast, in the CF-BFR, the UE may transmit a preamble allocated in a UE-specific manner by the base station. In the CB-BFR, the base station may allocate the same preamble to a plurality of UEs. In the CF-BFR, the base station may allocate a preamble in a UE-specific manner.

Note that the CB-BFR and the CF-BFR may be referred to as CB PRACH-based BFR (contention-based PRACH-based BFR (CBRA-BFR)) and CF PRACH-based BFR (contention-free PRACH-based BFR (CFRA-BFR)), respectively. The CBRA-BFR may be referred to as CBRA for BFR. The CFRA-BFR may be referred to as CFRA for BFR.

In any of the CB-BFR and the CF-BFR, information related to a PRACH resource (RA preamble) may be notified by higher layer signaling (RRC signaling or the like), for example. For example, the information may include information indicating a correspondence between a detected DL-RS (beam) and a PRACH resource, and a different PRACH resource may be associated with each DL-RS.

At step S105, the base station that has detected the BFRQ transmits a response signal (which may be referred to as a gNB response and the like) for the BFRQ from the UE. The response signal may include reconfiguration information about one or a plurality of beams (for example, DL-RS resource configuration information).

The response signal may be transmitted in a UE-common search space of a PDCCH, for example. The response signal may be notified by using a PDCCH (DCI) having a cyclic redundancy check (CRC) scrambled with a UE identifier (for example, a cell-radio RNTI (C-RNTI). The UE may judge at least one of a transmit beam and a receive beam to use, based on the beam reconfiguration information.

The UE may monitor the response signal, based on at least one of a control resource set (CORESET) for BFR and a search space set for BFR.

With respect to the CB-BFR, when the UE receives a PDCCH corresponding to a C-RNTI related to the UE itself, it may be judged that contention resolution has succeeded.

With respect to processing at step S105, a period for the UE to monitor a response from the base station (for example, gNB) to the BFRQ may be configured. The period may be referred to as, for example, a gNB response window, a gNB window, a beam recovery request response window, and the like. The UE may perform retransmission of the BFRQ when there is no gNB response detected in the window period.

At step S106, the UE may transmit, to the base station, a message indicating that beam reconfiguration has been completed. For example, the message may be transmitted on a PUCCH, or may be transmitted on a PUSCH.

Beam recovery success (BR success) may represent, for example, a case where step S106 has been reached. On the other hand, beam recovery failure (BR failure) may correspond to, for example, a case that BFRQ transmission has reached a given number of times or a case that a beam failure recovery timer (Beam-failure-recovery-Timer) has expired.

In Rel. 15, it is supported to perform a beam recovery procedure for beam failure detected in an SpCell (PCell/PSCell) (for example, notification of BFRQ), by using a random access procedure.

In contrast, in Rel. 16, it is supported to perform a beam recovery procedure for beam failure detected in an SCell (for example, notification of BFRQ (step S104 in FIG. 1)) by using at least one of transmission of a PUCCH (for example, a scheduling request (SR)) for BFR and transmission of a MAC CE (for example, a UL-SCH) for BFR. For example, the UE may transmit information related to beam failure by using two MAC CE based steps. The information related to beam failure may include information related to the cell in which the beam failure is detected and information related to a new candidate beam (or a new candidate RS index).

### {Step 1}

When BF is detected, PUCCH-BFR (scheduling request (SR)) may be transmitted from the UE to the SpCell (for example, the PCell/PSCell). The PUCCH-BFR may be referred to as a PUCCH-SR, a PUCCH-SR for BFR, or a PUCCH for SR.

Next, UL grant (for example, DCI) for step 2 below may be transmitted from the PCell/PSCell to the UE. When a MAC CE (or a UL-SCH) for transmitting information related to a new candidate beam is present in a case where no beam failure is detected, step 2 (for example, MAC CE transmission) may be performed while step 1 (for example, PUCCH transmission) is omitted.

### {Step 2}

The UE may transmit the information related to the (failed) cell in which the beam failure is detected (for example, a cell index) and the information related to the new candidate beam, to the base station (PCell/PSCell) through an uplink channel (for example, a PUSCH) by using a MAC CE. Thereafter, the BFR procedure is performed, and a given period (for example, 28 symbols) after reception of a response signal from the base station, QCL of a PDCCH/PUCCH/PDSCH/PUSCH may be updated to a new beam.

Note that these step numbers are just numbers for description, and a plurality of steps may be combined with each other, or the order of the steps may be changed. Whether to perform the BFR may be configured for the UE by using higher layer signaling.

For future radio communication systems (for example, Rel. 17 or later versions), enhancement of beam management for a UE having a plurality of panels (multi-panel) or beam management using a plurality of transmission/reception points (multi-transmission/reception points (TRPs)) is under study.

It is also assumed, in beam failure detection/beam failure recovery in Rel. 17 or later versions, to support a BFRQ framework based on SCell BFR BFRQ of Rel. 16. In this case, up to X (for example, X for each cell group) PUCCH-SR resources (for example, dedicated PUCCH-SR resources) may be configured for the UE. X may be one or may be two or two or more. The PUCCH-SR resource may be interpreted as PUCCH resources for SR.

In the present disclosure, the cell group may be, for example, at least one of a master cell group (MCG), a secondary cell group (SCG), and a PUCCH cell group. The MCG and the SCG may be groups configured in dual connectivity (DC). The PUCCH group may be a group configured in PUCCH transmission. The PUCCH group may include at least a PCell/PSCell in which the PUCCH transmission is performed or an SCell in which PUCCH transmission is performed (also referred to as a PUCCH SCell). In the following description, a cell group may be interpreted as a PUCCH group.

It is conceivable to perform beam failure detection/beam failure recovery for each TRP/UE panel (for example, per-TRP BFR) in a given cell in Rel. 17 or later versions. Per-TRP failure detection/beam failure recovery may be referred to as BFR in TRP units and TRP-specific BFR (for example, TRP-specific BFR).

When a BFR procedure (for example, transmission of a scheduling request (SR) or the like) in TRP units is supported, how to control configuration of a scheduling request (for example, SR configuration) is a problem.

For example, how to control configuration of an SR (for example, an SR index/SchedulingRequestID/SR ID) and configuration of a PUCCH resource (for example, a PUCCH resource for SR) for a cell group (or a cell/BWP/TRP) is a problem. Alternatively, when BFR in TRP units is supported, how to control a cell/TRP in which a PUCCH for SR to be used for transmission of an SR/SR is a problem when beam failure is detected in TRP units/cell units (for example, when an SR is triggered).

The inventors of the present invention focused on a case where a beam failure recovery procedure (UE operation based on beam failure detection/beam failure recovery request/beam failure recovery) is applied in units of one or more TRPs/panels, studied configuration of an SR/control of transmission of an SR in such a case, and came up with the idea of the present embodiment.

Embodiments according to the present disclosure will be described in detail with reference to the drawings as follows. The aspects may each be employed individually, or may be employed in combination.

In the present disclosure, a UE may be a UE that performs transmission/reception with a TRP by using a plurality of panels. Each panel may correspond to a different TRP, one panel may correspond to a plurality of TRPs, or a plurality of panels may correspond to one TRP.

In the present disclosure, a panel (or a panel index) of the UE may correspond to a specific group. In this case, the UE may assume that beams/RSs of each group are measured in each panel of the UE. The UE may assume to simultaneously receive beams of a plurality of groups (by using different panels).

In the present disclosure, a TRP may be interpreted as a panel of a TRP (or a base station), an RS group, an antenna port group, a spatial relation group, a QCL group, a TCI state, a TCI state group, a CORESET group, a CORESET pool, and the like, and vice versa. A TRP index may be interpreted as an RS group index, an antenna port group index, a QCL group index, a TCI state index, a TCI state group index, a CORESET group index, a CORESET pool index, and the like, and vice versa.

In the present disclosure, TRP #1 and TRP #2 may be referred to as CORESET pool index #1 and CORESET pool index #2, BFD-RS set #1 and BFD-RS set #2, or TCI state #1 and TCI state #2, respectively. Association between a PUCCH resource for SR and a TRP may be referred to as association between a PUCCH resource for SR and a BFD-RS (BFD-RS set).

In the present disclosure, a panel of the UE may be interpreted as an RS group, an antenna port group, a spatial relation group, a QCL group, a TCI state group, a CORESET group, and the like, and vice versa.

In the present disclosure, a panel may be associated with a group index of an SSB/CSI-RS group. In the present disclosure, a panel may be associated with a TRP. In the present disclosure, a plurality of panels may be associated with a group index of a group beam based report. In the present disclosure, a panel may be associated with a group index of an SSB/CSI-RS group for a group beam based report.

In the present disclosure, a serving cell/cell may be interpreted as a PCell, a PSCell, an SpCell, or an SCell. In the following description, a case where two TRPs correspond to a serving cell is used as an example. However, three or more TRPs may correspond to a serving cell.

In the present disclosure, a BFD RS for which beam failure is detected, a (failed) BFD RS, a TRP for which beam failure is detected, a (failed) TRP, a UE panel for which beam failure is detected, and a (failed) UE panel may be interchangeably interpreted.

In the present disclosure, A/B may be interpreted as at least one of A and B or A and B. In the present disclosure, A/B/C may be interpreted as at least one of A, B, and C.

### (Example of Configuration of SR)

In configuration of an SR, at least one of options 0, 1, and 2 below may be supported.

### <Option 0>

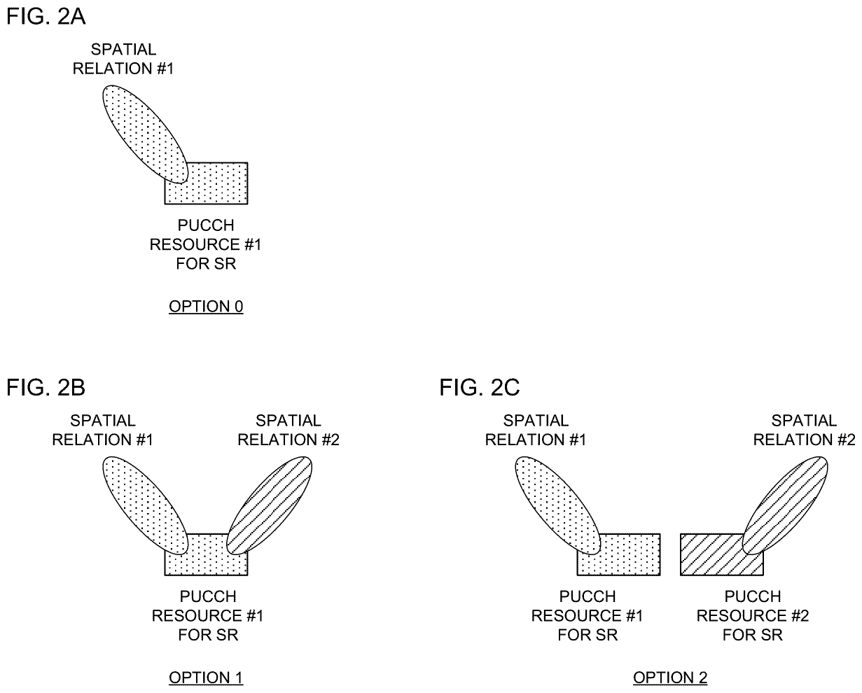

X₀ PUCCH resource (s) (or PUCCH (s) for SR) is configured for an SR (for example, an SR index/SchedulingRequestID) in a cell group, and Y₀ spatial relation(s) is configured for a PUCCH resource. In the following description, assume that X₀=1 and Y₀=1 (refer to FIG. 2A).

FIG. 2A shows a case where one PUCCH resource for SR (here, PUCCH resource #1 for SR) is configured for an SR configured for a cell group (or an SpCell), and one spatial relation (here, spatial relation #1) is configured for the PUCCH resource for SR. Note that the number X₀ and the number Y₀ are not limited to these.

In option 0, a method of configuring an SR for SCell BFR in Rel. 16 may be applied. Option 0 may be interpreted as a 0-th SR/0-th SR configuration.

### <Option 1>

For an SR (for example, an SR index/SchedulingRequestID) for each cell group, X₁ PUCCH resource (s) (for example, a dedicated PUCCH-SR resource (s)) is configured, and Y₁ spatial relation(s) is configured for a PUCCH resource, at maximum in the cell group. In the following description, assume that X₁=1 and Y₁₌₂ (refer to FIG. 2B).

FIG. 2B shows a case where one PUCCH resource for SR (here, PUCCH resource #1 for SR) is configured for an SR configured for a cell group (or an SpCell), and two spatial relations (here, spatial relations #1 and #2) are configured for the PUCCH resource for SR. Note that the number X₁ and the number Y₁ are not limited to these. Option 1 may be interpreted as a first SR/first SR configuration.

### <Option 2>

For an SR (for example, an SR index/SchedulingRequestID) for each cell group, X₂ PUCCH resource (s) (for example, a dedicated PUCCH-SR resource (s)) is configured, and Y₂ spatial relation (s) is configured for a PUCCH resource, at maximum in the cell group. In the following description, assume that X₂=2 (or 2 or larger) and Y₂=1 (refer to FIG. 2C).

FIG. 2C shows a case where two PUCCH resource for SR (here, PUCCH resources #1 and #2 for SR) are configured for an SR configured for a cell group (or an SpCell), and one spatial relation (here, a corresponding one of spatial relations #1 and #2) is configured for each PUCCH resource for SR. FIG. 2C shows a case where different spatial relations are configured for PUCCH resource #1 for SR and PUCCH resource #2 for SR, but the same spatial relation may be configured for PUCCH resource #1 for SR and PUCCH resource #2 for SR. Note that the number X₂ and the number Y₂ are not limited to these. Option 2 may be interpreted as a second SR/second SR configuration.

The UE may receive at least one of information related to an SR (for example, an SR index/SchedulingRequestID) in a cell group, information related to a PUCCH resource (for example, a PUCCH-SR resource) in a cell group, and information related to a spatial relation (for example, spatial relation) configured for a PUCCH resource, from a network (for example, a base station) by using higher layer signaling/DCI.

The information related to an SR may be at least one of information indicating a configured SR index (or SchedulingRequestID) and the number of configured SRs. The information related to a PUCCH resource in a cell group may be at least one of information indicating the PUCCH resource and information indicating the number of configured PUCCH resources. The information related to a spatial relation may be at least one of information indicating the spatial relation and the number of configured spatial relations. In the present disclosure, a spatial relation (for example, spatial relation), a beam, a spatial filter, a spatial domain filter, a TCI state, and QCL may be interchangeably interpreted.

The UE may receive, for each cell (for example, each cell included in a cell group), information related to configuration of BFR in TRP units from the network (for example, the base station) by using higher layer signaling/DCI. The information related to configuration of BFR in TRP units may be information indicating presence of the configuration/application of the BFR in TRP units. Alternatively, the information related to configuration of BFR in TRP units may be information indicating a TRP type (BFR in TRP units or cell-specific BFR).

The UE may control transmission of an SR or a PUCCH-SR, based on at least one of the number of SRs (or the number of SR indices) configured for each cell group and a BFR type (for example, BFR per TRP/BFR per cell) configured for/applied to a specific cell included in a cell group. In this case, the UE may control transmission of an SR or a PUCCH for SR (PUCCH-SR), based on at least one of the number of configured PUCCH resources and the number of spatial relations configured for (or corresponding to) a PUCCH resource.

### (Selection of PUCCH Resource for SR)

When beam failure in TRP units is applied/configured, how to control a PUCCH resource for SR is a problem. When beam failure is detected (for example, the received power of a BFD-RS/BFD-RS set is lower than a threshold) in a given TRP, at least one of selection method 1 to selection method 3 below may be applied as selection of a PUCCH resource for SR, for example. A BFD-RS and a BFD-RS set may be interchangeably interpreted below.

### <Selection Method 1>

A PUCCH resource for SR associated with another BFD-RS set different from a BFD-RS set in which beam failure is detected is selected. The other BFD-RS set may be referred to as a BFD-RS set in which no beam failure is detected/with a received power not being lower than the given threshold (for example, other/non-failed BFD-RS set).

### <Selection Method 2>

A PUCCH resource for SR associated with a BFD-RS set in which beam failure is detected is selected. The BFD-RS set in which beam failure is detected may be referred to as a BFD-RS set with a received power being lower than the given threshold (or being equal to or lower than the given threshold) (for example, a failed BFD-RS set).

### <Selection Method 3>

The UE selects a PUCCH resource for SR (UE implementation).

### (Configuration of BFD-RS Set)

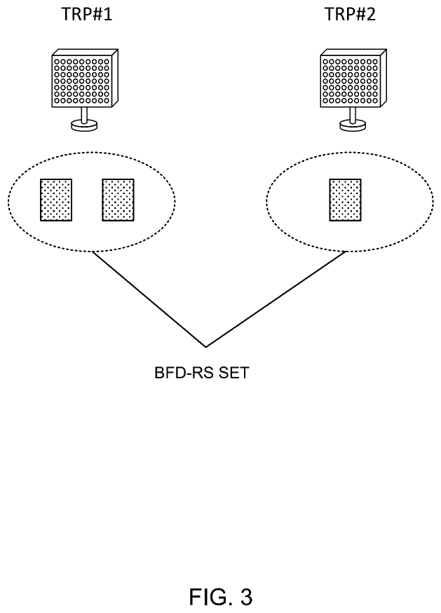

A BFD-RS set may include one or a plurality of (for example, two) BFD-RSs. In Rel. 17 or later versions, it is assumed that a plurality of (for example, two) BFD-RS sets are supported in BFR in TRP units (refer to FIG. 3). FIG. 3 shows a case where two BFD-RS sets are configured for TRP #1 and one BFD-RS set is configured for TRP #2. The BFD-RS set may be configured for each BWP/cell.

When a BFD-RS for BFR in TRP units (for example, TRP-specific BFR) is supported, the total number of RSs in a plurality of (for example, two) BFD-RS sets per DL BWP may be determined based on UE capability. The maximum number of RSs per BFD RS set may be determined based on a given value (for example, two) or UE capability.

As a beam failure detection criterion for each BFD-RS set, the UE (for example, the physical layer of the UE) may measure/evaluate radio link quality for each BFD-RS set and indicate, when virtual PDCCH BLERS of all the BFD-RSs in a corresponding BFD-RS set are higher than a given threshold, the index of the BFD-RS set to a higher layer in each given period (for example, X ms).

One PUCCH resource for SR may be configured in a cell group, for the UE configured with BFR in TRP units (for example, TRP-specific BFR). Alternatively, the maximum number of a plurality of (for example, two) PUCCH resources for SR may be configured in the cell group.

A case where two PUCCH resources for SR are configured and beam failure is detected (or when a BFD-RS set fails) in one BFD-RS set at maximum for each cell is assumed. In this case, when all the BFD-RS sets in which beam failure is detected among cells are associated with the same PUCCH resource for SR in a rule of selecting a PUCCH resource for SR, selection method 1 or selection method 2 above may be adopted, and selection method 3 may be adopted otherwise.

### (First Aspect)

In a first aspect, description will be given of selection of a PUCCH resource for SR when update of a PUCCH resource after a procedure of BFR in TRP units (for example, multi-TRP BFR) is supported.

It may be supported that, after the BFR procedure is completed (for example, after BFR completion), it may be supported that not only a PUCCH resource for SR but also another PUCCH resource related to a TRP in which beam failure is detected/TRP in which no beam failure is detected are updated to a PUCCH resource corresponding to q_new. q_new may be an RS (or an RS index) corresponding to a new candidate beam specified in the BFR procedure in TRP units.

When the update of a PUCCH resource after the BFR procedure is also take into account, a PUCCH resource for SR associated with another BFD-RS set different from a BFD-RS set in which beam failure is detected may be selected as a PUCCH resource for SR in the BFR procedure (selection method 1). Alternatively, when a PUCCH resource for SR not associated with any BFD-RS set is configured, the PUCCH resource for SR may be selected.

For example, it is assumed that a TRP ID/CORESET pool ID is configured for each PUCCH resource, beam failure is detected (or failure occurs) with a given TRP ID/CORESET pool ID.

More specifically, it is assumed that first PUCCH resource #0 for SR is configured with TRP ID/CORESET pool ID=0 and second PUCCH resource #1 for RS is configured with TRP ID/CORESET pool ID=1. A case where beam failure is detected (failure occurs) with a TRP ID/CORESET pool ID=0 is assumed.

### <Case of Applying Selection Method 1>

When selection method 1 is applied as a rule of selecting a PUCCH resource for SR, the UE selects PUCCH resource #1 for SR to control transmission of an SR and the like. The base station may configure spatial relation #1 for PUCCH resource #1 for SR in advance. Spatial relation #1 may be configured to be transmitted by TRP #1.

After the base station has responded about BFR completion, a spatial relation updating rule may be applied. For example, a PUCCH/PUCCH resource for SR not used for SR transmission from the UE (here, PUCCH resource #0) may be updated to q_new (or a PUCCH resource corresponding to q_new).

In this way, the PUCCH resource not used for SR transmission (PUCCH resource related to a BFD-RS/TRP in which beam failure is detected) is updated. When control of update of a spatial relation of a PUCCH after BFR completion is taken into account, it is only needed, by applying selection method 1, to update a PUCCH/PUCCH resource for SR not used for SR transmission (or a PUCCH/PUCCH resource for SR related to a TRP in which beam failure has occurred).

### <Case of Applying Selection Method 2>

When selection method 2 is applied as a rule of selecting a PUCCH resource for SR, the UE selects PUCCH resource #0 for SR to control transmission of an SR and the like. The base station may configure spatial relation #1 for PUCCH resource #0 for SR in advance. Spatial relation #1 may be configured to be transmitted by TRP #1.

After the base station has responded about BFR completion, a spatial relation updating rule may be applied. For example, a PUCCH/PUCCH resource for SR not used for SR transmission from the UE (here, PUCCH resource #1) may be updated to q_new (or a PUCCH resource corresponding to q_new).

In selection method 2, the PUCCH resource not used for SR transmission is a PUCCH resource related to a BFD-RS/TRP in which no beam failure is detected. Hence, when selection method 2 is applied, it is necessary to support update of a PUCCH/PUCCH resource for SR related to a TRP in which no beam failure is detected (or which has not failed), after BFR completion.

Alternatively, when selection method 2 is applied, it may be configured to update a PUCCH resource for SR used for SR transmission after BFR completion.

### (Second Aspect)

In a second aspect, description will be given of an example of a BFR procedure in a case where different TRPs are configured among cells.

When a plurality of cells are configured, the UE may be configured with a TRP separately for each cell. Whether to apply BFR in TRP units may be commonly configured or separately configured within each cell/among the cells.

For example, the UE may be configured/applied with a plurality of (for example, two) TRPs in a first cell and one TRP in a second cell.

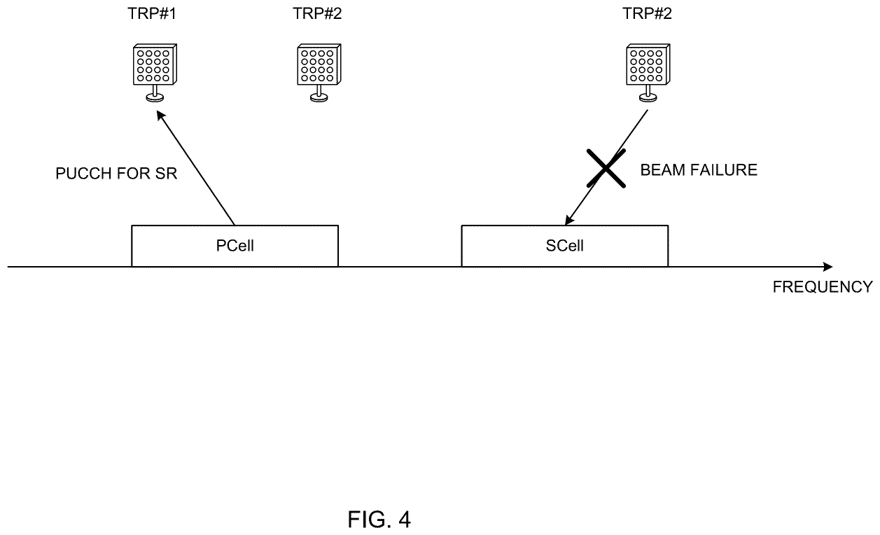

FIG. 4 shows a case where the first cell and the second cell are configured for the UE, and TRP #1 and TRP #2 are configured for the first cell while TRP #2 is configured for the second cell (for example, TRP #1 is not configured in the second cell or TRP #1 is set at off). Note that the TRP configured for the second cell may be TRP #3. Here, a case where the first cell is an SpCell (for example, a PCell/PSCell) and the second cell is an SCell is shown. Note that the first cell and the second cell are not limited to these.

In the following description, the second cell may belong to the same cell group as that of the PCell. The cell group may be a PUCCH group (for example, UCI of the second cell may be transmitted by using a PUCCH of the first cell). Alternatively, the second cell may be a PUCCH-SCell in which PUCCH transmission is possible (or the first cell and the second cell may be configured to belong to different PUCCH cell groups). Alternatively, the first cell may be a PUCCH-SCell, and the second cell may be an SCell belonging to the same cell group as that of the PUCCH-SCell.

In FIG. 4, two TRPs are configured in the first cell. Hence, configuration of one or two BFD-RS sets may be supported in the first cell. In contrast, one TRP is configured (TRP #1 is not configured or TRP #1 is set at off) in the second cell. Hence, configuration of one BFD-RS set may be supported (or configuration of two BFD-RS sets need not be supported) in the second cell.

In this way, by supporting configuration of separately configuring a TRP to be configured/applied/set at on for each given cell, maximization of throughput in millimeter waves (mmWave) can be attempted. For example, when TRP #1 in the SCell is set at off, only TRP #2 may be present in the SCell.

As described above, when one TRP is configured/applied in a given cell (SCell in FIG. 4) and beam failure is detected (or an SR is triggered) in a TRP in the SCell, the UE may perform control to perform transmission of a PUCCH for SR to a TRP in another cell (PCell/PSCell in FIG. 4). In an example, a case where the UE transmits a PUCCH for SR to TRP #1 in the first cell is shown.

When beam failure in TRP units is detected in a given cell, the UE may control transmission of an SR/PUCCH for SR, based on whether another TRP in which no beam failure is detected (or non-failed TRP) is present in the cell. The UE may perform control to perform beam failure detection in TRP units (or beam failure recovery in TRP units) when a given higher layer parameter is configured or when a BFD-RS in TRP units is configured.

When beam failure is detected in one TRP (for example, one TRP index) or when beam failure is detected only for one BFD-RS set, the UE may perform control to transmit a PUCCH for SR to a TRP in which no beam failure is detected.

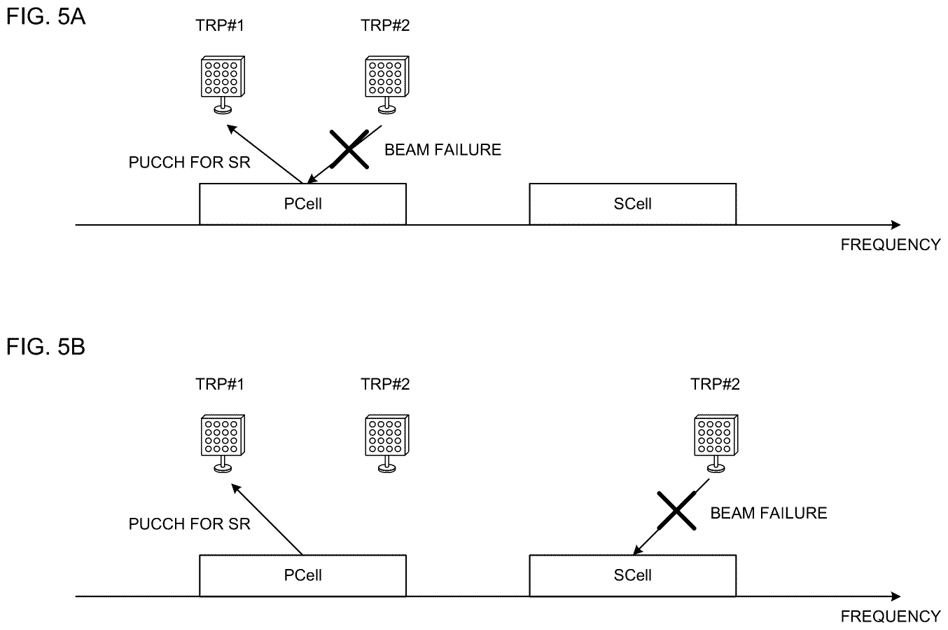

In this case, when another TRP (for example, a TRP in which no beam failure is detected) is present in a cell in which beam failure in TRP units is detected, the UE may transmit a PUCCH for SR in the cell (refer to FIG. 5A). FIG. 5A shows a case where beam failure is detected in TRP #2 in the first cell and a PUCCH for SR is transmitted to another TRP (here, TRP #1) in the first cell.

When another TRP (for example, a TRP in which no beam failure is detected) is not present in a cell in which beam failure in TRP units is detected, the UE may transmit a PUCCH for SR in another cell (refer to FIG. 5B). FIG. 5B shows a case where beam failure is detected in TRP #2 in the second cell and a PUCCH for SR is transmitted to a TRP (here, TRP #1) in the first cell. Note that transmission of the PUCCH for SR to TRP #2 in the first cell may be permitted.

Thus, when a TRP configured/applied/set at on is configured separately for each cell, SR transmission can be appropriately performed by controlling the SR transmission according to whether another TRP in which no beam failure is detected is present, in a cell in which beam failure in TRP units is detected.

### (Third Aspect)

In a third aspect, description will be given of an example of configuration of a PUCCH resource for SR.

The UE may be configured with one or a plurality of (for example, two) PUCCH resources for SR, for BFR in TRP units. One or a plurality of (for example, two) spatial relations may be configured for the PUCCH resource for SR. The PUCCH resource for SR may be interpreted as a PUCCH for SR, a PUCCH set for SR, or a PUCCH resource set for SR.

The PUCCH resource for SR may be configured for at least one of an SpCell (for example, a PCell/PSCell) and a PUCCH-SCell. Alternatively, the PUCCH resource for SR may be configured for a cell group.

When no PUCCH (PUCCH on SCell or PUCCH-SCell) in the SCell is configured, the UE may transmit a PUCCH for SR to the SpCell irrespective of in which cell beam failure in TRP units is detected (or even when beam failure in TRP units is detected in any cell).

When no PUCCH (PUCCH on SCell or PUCCH-SCell) in the SCell is configured, transmission of the PUCCH for SR may be controlled by taking account of beam failure in TRP units.

For example, when beam failure in TRP units is detected in the SpCell, the UE may perform control to transmit the PUCCH for SR to the SpCell. When beam failure in TRP units is detected in the SCell, the UE may perform control to transmit the PUCCH for SR to the PUCCH-SCell. The SCell may be an SCell belonging to the same PUCCH group as that of the PUCCH-SCell.

Association between a TRP index and a PUCCH resource (for example, a PUCCH resource for SR) may be configured explicitly/implicitly.

A TRP index may be configured to be configured for each PUCCH resource. For example, the PUCCH resource and the TRP index may be associated in the same higher layer parameter for configuration.

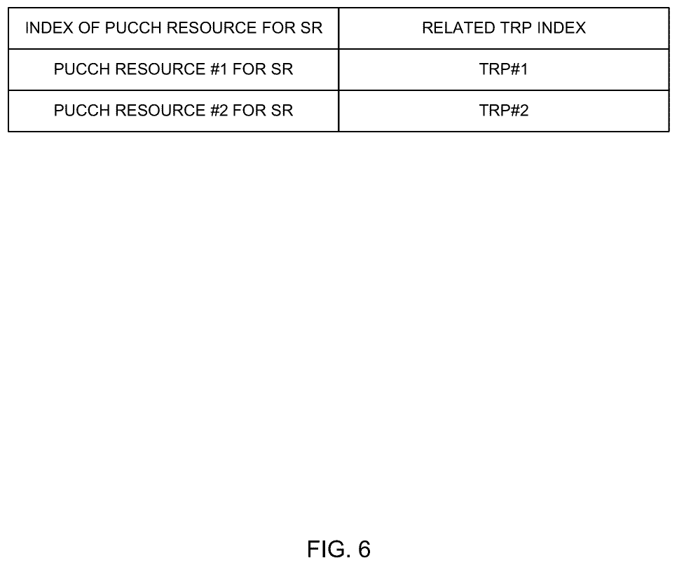

The TRP indices may be configured to be configured separately from the PUCCH resources (refer to FIG. 6). FIG. 6 shows a case where each PUCCH resource index and a related TRP index are configured/notified/activated by RRC/a MAC CE.

Note that a TRP index may be interpreted as a CORESET pool ID.

When no association between a PUCCH resource and a TRP index is configured, this may mean that the PUCCH resource is not associated with a specific TRP. The PUCCH resource may be applied to BFR in cell units (for example, per Cell BFR)/BFR in TRP units.

Alternatively, a PUCCH resource and a BFD-RS set (or a BFD-RS) may be associated, and a BFD-RS set and a TRP (or a CORESET pool ID) may be associated.

### (Fourth Aspect)

In a fourth aspect, description will be given of a case where a PUCCH resource for SR not associated with a TRP in which beam failure is detected when BFR in TRP units is performed is preferentially selected/applied.

Assume a case where a plurality of (for example, two) PUCCH resources for SR are configured and transmission of an SR is triggered. In such a case, the UE may select a PUCCH resource for SR not associated with a TRP in which beam failure is detected (or a failed TRP) to control the transmission of an SR. In other cases (for example, when no PUCCH resource for SR not associated with a TRP in which beam failure is detected is present), the UE may autonomously select a PUCCH resource for SR (UE implementation).

When the UE has found/recognized at least one of a PUCCH resource for SR associated with a TRP in which no beam failure is detected (or a non-failed TRP) and a PUCCH resource for SR not associated with a TRP, the UE only needs to select the PUCCH resource for SR.

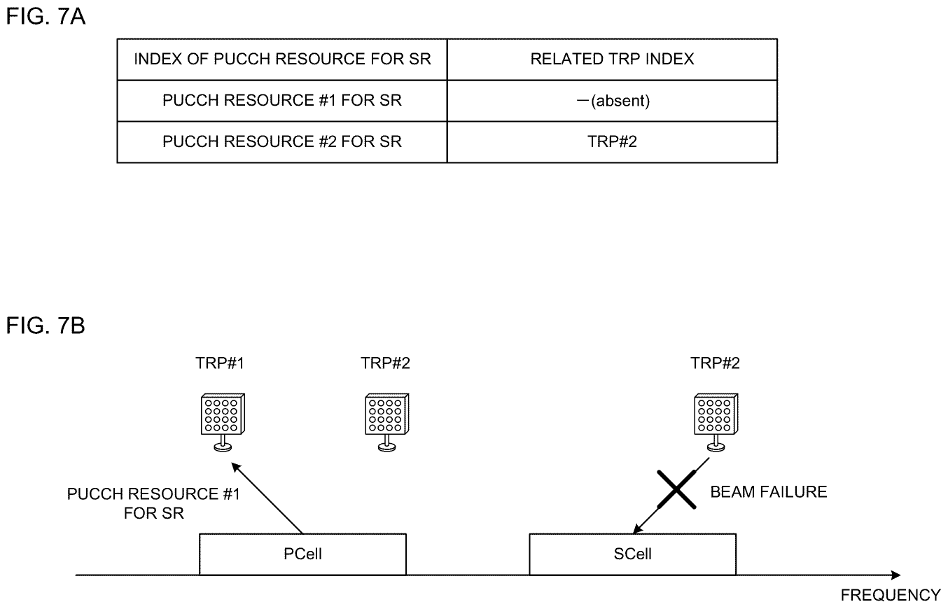

FIG. 7A shows a case where no TRP is associated with PUCCH resource #1 for SR and TRP #2 is associated with PUCCH resource #2 for SR. Association (including presence of association) between a PUCCH resource for SR and a TRP may be configured/activated for the UE by RRC/a MAC CE.

FIG. 7B shows a case where two TRPs (here, TRP #1 and TRP #2) are configured/applied/set at on in a first cell (for example, an SpCell) and one TRP (here, TRP #2) is configured/applied/set at on in a second cell (for example, an SCell).

When beam failure is detected (or an SR is triggered) for TRP #2 in the SCell one TRP, the UE may perform control to transmit a PUCCH for SR to a TRP #1 in first cell. In this case, the UE may preferentially select a PUCCH resource for SR not associated with TRP #2 (here, PUCCH resource #1 for SR) as a PUCCH resource to be used for the transmission of an SR.

In this way, even when a TRP/PUCCH resource for SR different per cell is configured and BFR in TRP units is employed, update of a PUCCH resource after transmission of a PUCCH for SR/a BFR procedure can be appropriately performed.

### <Configuration of PUCCH Resource for SR>

A PUCCH resource for SR may be configured for each cell/CC (or for each TRP).

### <Case 4-1>

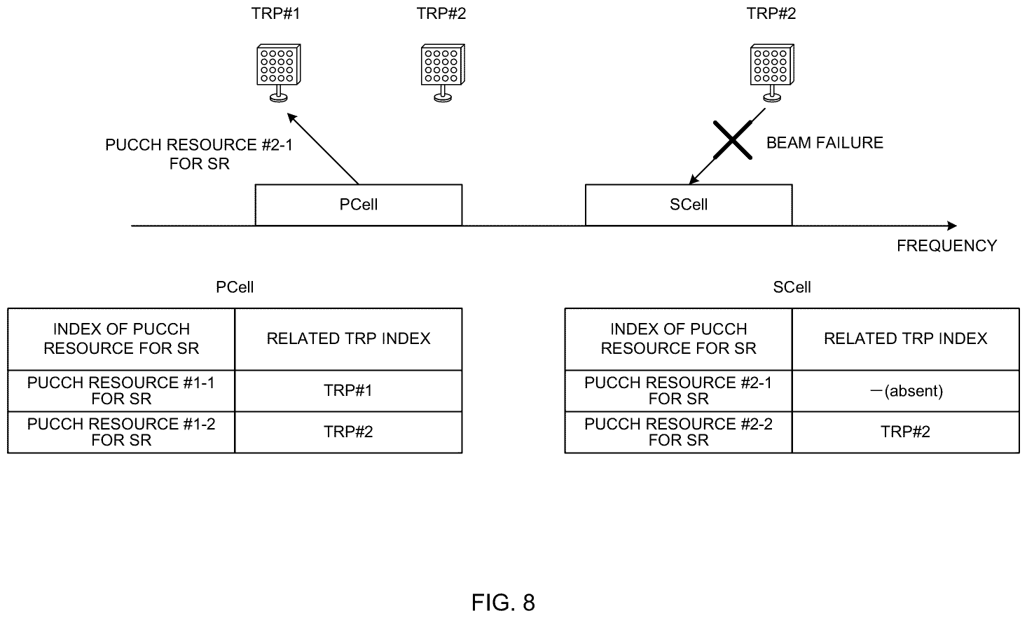

FIG. 8 shows a case where a plurality of (here, two) PUCCH resources #1-1 and #1-2 for SR are configured for the first cell and a plurality of (here, two) PUCCH resources #2-1 and #2-2 for SR are configured for the second cell. Here, shown is a case where two TRPs (here, TRP #1 and TRP #2) are configured/applied/set at on in a first cell (for example, an SpCell) and one TRP (here, TRP #2) is configured/applied/set at on in a second cell (for example, an SCell).

Shown is also a case where PUCCH resource #1-1 for SR is associated with TRP #1 and PUCCH resource #1-2 for SR is associated with TRP #2. Shown is also a case where PUCCH resource #2-1 for SR is not associated with any TRP and PUCCH resource #2-2 for SR is associated with TRP #2.

The UE may be notified of information related to a PUCCH resource for SR configured for each cell by the base station by RRC/a MAC CE/DCI. The UE may be notified of association (which may include presence of association) between a PUCCH resource for SR configured for each cell and a TRP by the base station by RRC/a MAC CE/DCI.

When beam failure is detected in a given cell, a PUCCH resource for SR associated with a cell in which beam failure is detected (or a failed CC) may be selected/transmitted (for example, preferentially selected/transmitted).

For example, in FIG. 8, assume a case where beam failure (BFR in TRP units) is detected in TRP #2 in the second cell. In this case, the UE may preferentially select/use a PUCCH resource for SR related to/corresponding to the second cell (PUCCH resource #2-1/#2-2 for SR). Here, a case where the UE selects/applies PUCCH resource #2-1 for SR not associated with TRP #2 for which beam failure is detected and transmits a PUCCH for SR to TRP #1 in the first cell is shown, but this is not restrictive. PUCCH resource #2-2 for SR may be selected/applied.

### <Case 4-2>

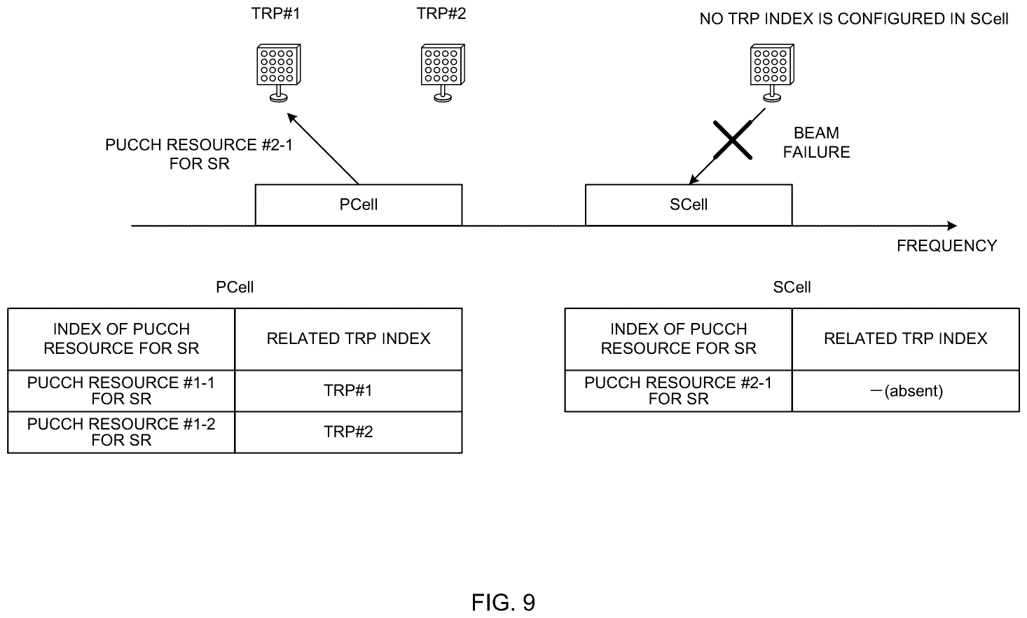

FIG. 8 shows a case where a TRP is configured (or BFR in TRP units is applied) for each of the plurality of (here, two) cells, but this is not restrictive. For example, it may be configured that no TRP is configured for (or BFR in TRP units is not applied to) a given cell (for example, the second cell) (refer to FIG. 9).

FIG. 9 shows a case where two TRPs (here, TRP #1 and TRP #2) are configured/applied/set at on in a first cell (for example, an SpCell) and no TRP (or no TRP index) is configured in a second cell (for example, an SCell). In this case, a plurality of (here, two) PUCCH resources #1-1 and #1-2 for SR may be configured for the first cell and one PUCCH resource #2-1 for SR may be configured for the second cell.

Shown is also a case where PUCCH resource #1-1 for SR is associated with TRP #1 and PUCCH resource #1-2 for SR is associated with TRP #2. Shown is also a case where PUCCH resource #2-1 for SR is not associated with any TRP.

For example, in FIG. 9, assume a case where beam failure (BFR in cell units) is detected in the second cell. In this case, the UE may preferentially select/use PUCCH resource #2-1 for SR related to/corresponding to the second cell to transmit a PUCCH for SR. The UE may perform control to transmit the PUCCH resource for SR to a TRP (here, TRP #1) in the first cell.

In this way, even when BFR in cell units is detected, a PUCCH for SR can be appropriately transmitted.

### <Case 4-3>

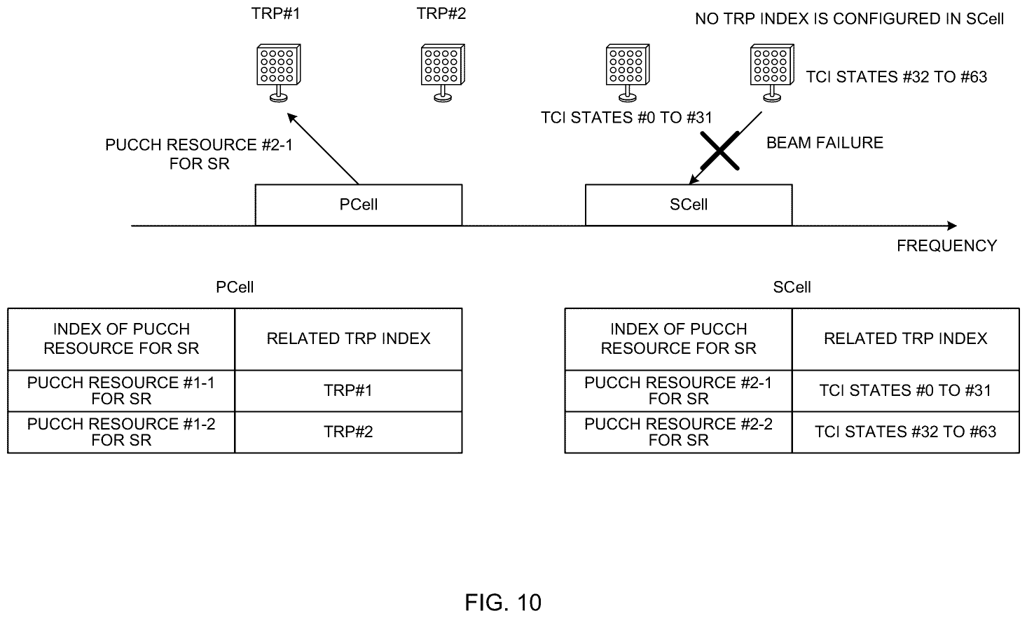

In a given cell, a TCI state/QCL assumption (for example, TCI-state/QCL assumption) may be configured in association with a PUCCH resource for SR (refer to FIG. 10).

FIG. 10 shows a case where BFR in two-TRP units (here, TRP #1 and TRP #2) are configured/applied in a first cell (for example, an SpCell) and no BFR in TRP TRP units is configured (or BFR in cell units is configured) in a second cell (for example, an SCell).

A plurality of (here, two) PUCCH resources #1-1 and #1-2 for SR may be configured for the first cell and two PUCCH resources #2-1 and #2-2 for SR may be configured for the second cell.

For example, this corresponds to a case where multi-TRP NCJT is employed in the first cell (here, the SpCell) and single-TRP is applied to the second cell (here, the SCell). The UE may assume that the single TRP transmits all the TCI states in the SCell. Different TRPs transmitting different TCI states may be supported by the NW. In this case, indication of a dynamic TCI state may mean dynamic point selection.

Here, a case where PUCCH resource #1-1 for SR is associated with TRP #1 and PUCCH resource #1-2 for SR is associated with TRP #2 is shown. Shown is also a case where PUCCH resource #2-1 for SR is associated with first TCI states/QCL (here, TCI states #0 to #31) and PUCCH resource #2-2 for SR is associated with second TCI states/QCL (here, TCI states #32 to #63).

When beam failure is detected in the second cell, the UE cannot grasp which TRP is related to a TRP in which the beam failure is detected (or a failed TRP).

Hence, when beam failure of a BFD-RS in a cell in which BFR in TRP units is not configured (for example, the second cell) is detected, the UE may control transmission of the SR by selecting/applying a PUCCH resource for SR, based on a given TCI state related to the BFD-RS for which the beam failure is detected. For example, the UE may select/apply a PUCCH resource for SR not related to the given TCI state. Alternatively, the UE may select/apply a PUCCH resource for SR related to the given TCI state.

In FIG. 10, assume a case where beam failure (BFR in cell units) is detected in the second cell. In this case, the UE may preferentially select/use a PUCCH resource for SR (here, PUCCH resource #2-1 for SR) not associated with the TCI corresponding to the BFD-RS for which beam failure is detected (here, any one of TCI states #32 to #63), to transmit a PUCCH for SR. The UE may perform control to transmit the PUCCH resource for SR to a TRP (here, TRP #1) in the first cell.

### <Variations>

Case 4-1 to Case 4-3 show cases where configuration of a different PUCCH resource for SR for each cell is supported, but this is not restrictive. For example, X (for example, X=2) PUCCH resources for SR are configured at maximum in cell group units, but association between a PUCCH resource for SR and a TRP index may be configured separately for each cell. For example, in FIG. 8 to FIG. 10, PUCCH resources #2-1 to #2-2 for SR may each be changed to #1-1 or #1-2.

Alternatively, the PUCCH resource for SR may be configured in cell group units (or for each cell group) in case 4-1 to case 4-3. Association between a PUCCH resource for SR and a TRP or association between a PUCCH resource for SR and a TCI state/QCL may be configured commonly for cell groups (or the SpCell, PUCCH-SCell).

### <Case 4-1′>

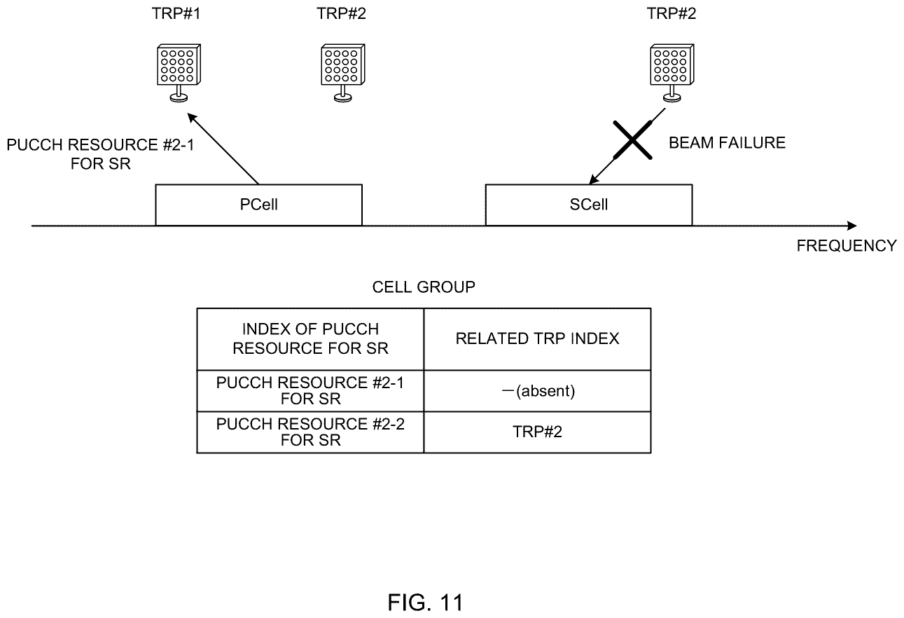

In case 4-1, the PUCCH resource for SR may be configured in cell group units (refer to FIG. 11).

FIG. 11 shows a case where a plurality of (here, two) PUCCH resources #2-1 and #2-2 for SR are configured for a cell group including the first cell and the second cell. Here, shown is a case where two TRPs (here, TRP #1 and TRP #2) are configured/applied/set at on in a first cell (for example, an SpCell) and one TRP (here, TRP #2) is configured/applied/set at on in a second cell (for example, an SCell).

Shown is also a case where PUCCH resource #2-1 for SR is not associated with any TRP and PUCCH resource #2-2 for SR is associated with TRP #2.

The UE may be notified of information related to a PUCCH resource for SR configured for each cell group (for example, SpCell or PUCCH-SCell) by the base station by RRC/a MAC CE/DCI. The UE may be notified of information related to association (which may include presence of association) between a PUCCH resource for SR configured for each cell group and a TRP by the base station by RRC/a MAC CE/DCI.

When beam failure is detected in a given cell, a PUCCH resource for SR for a cell group associated with a cell in which beam failure is detected (or a failed CC) may be selected/transmitted.

For example, in FIG. 11, assume a case where beam failure (BFR in TRP units) is detected in TRP #2 in the second cell. In this case, the UE may preferentially select/use a PUCCH resource for SR related to/corresponding to the cell group including the second cell (PUCCH resource #2-1/2-2 for SR). Here, a case where the UE selects/applies PUCCH resource #2-1 for SR not associated with TRP #2 for which beam failure is detected and transmits a PUCCH for SR to TRP #1 in the first cell is shown, but this is not restrictive. PUCCH resource #2-2 for SR may be selected/applied.

### <Case 4-2′>

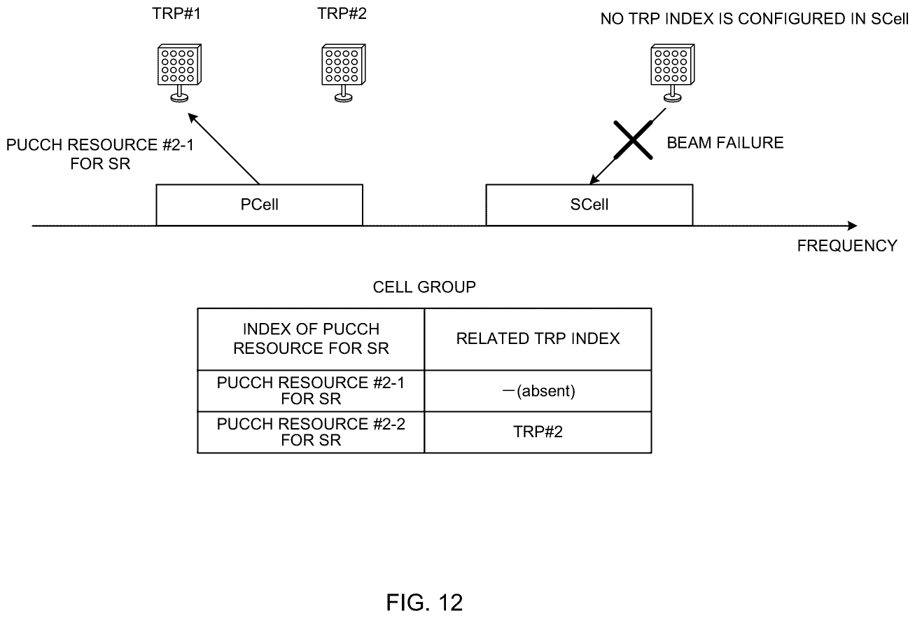

In case 4-2, the PUCCH resource for SR may be configured in cell group units (refer to FIG. 12).

FIG. 12 shows a case where two TRPs (here, TRP #1 and TRP #2) are configured/applied/set at on in a first cell (for example, an SpCell) and no TRP (or no TRP index) is configured in a second cell (for example, an SCell). In this case, a plurality of (here, two) PUCCH resources #2-1 and #2-2 for SR may be configured for a cell group including a first cell and a second cell.

For example, in FIG. 12, assume a case where beam failure (BFR in cell units) is detected in the second cell. In this case, the UE may preferentially select/use PUCCH resource #2-1 for SR related to/corresponding to the second cell to transmit a PUCCH for SR. The UE may perform control to transmit the PUCCH resource for SR to a TRP (here, TRP #1) in the first cell.

Shown is also a case where PUCCH resource #2-1 for SR is not associated with any TRP and PUCCH resource #2-2 for SR is associated with TRP #2.

For example, in FIG. 12, assume a case where beam failure (BFR in cell units) is detected in the second cell. In this case, the UE may select/use a PUCCH resource for SR related to/corresponding to a cell group including the second cell, to transmit a PUCCH for SR. Here, a case where the UE selects/applies PUCCH resource #2-1 for SR not associated with any TRP and transmits a PUCCH for SR to TRP #1 in the first cell is shown, but this is not restrictive. PUCCH resource #2-2 for SR may be selected/applied.

### <Case 4-3′>

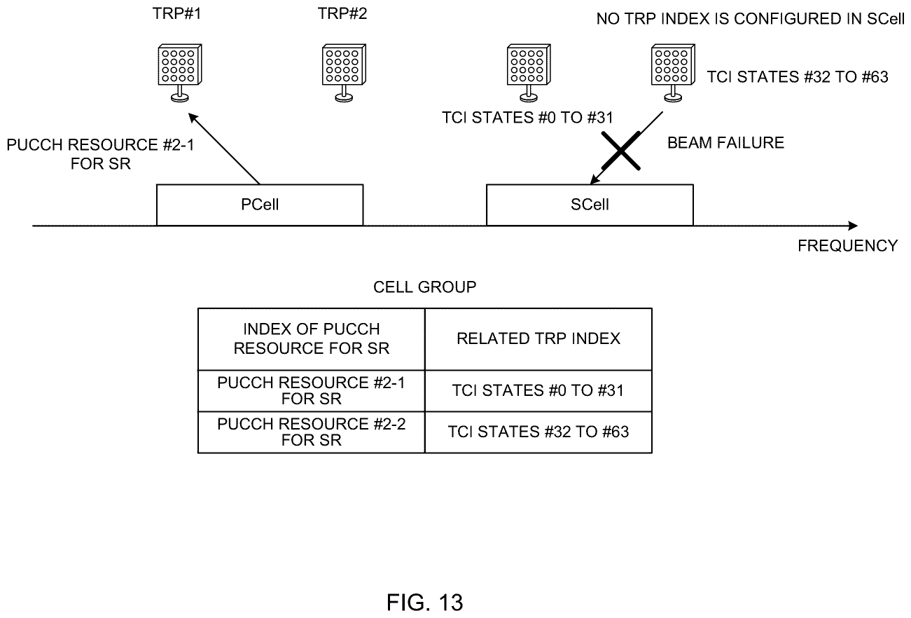

In case 4-3, the PUCCH resource for SR may be configured in cell group units (refer to FIG. 13).

Shown is a case where a plurality of (here, two) PUCCH resources #2-1 and #2-2 for SR are configured for a cell group including the first cell and the second cell.

Here, a case where PUCCH resource #2-1 for SR is associated with the first TCI state/QCL (here, TCI states #0 to #31) and PUCCH resource #2-2 for SR is associated with the second TCI states/QCL (here, TCI states #32 to #63) is shown.

In FIG. 13, assume a case where beam failure (BFR in cell units) is detected in the second cell. In this case, the UE may preferentially select/use a PUCCH resource for SR (here, PUCCH resource #2-1 for SR) not associated with the TCI corresponding to the BFD-RS for which beam failure is detected (here, any one of TCI states #32 to #63), to transmit a PUCCH for SR. The UE may perform control to transmit the PUCCH resource for SR to a TRP (here, TRP #1) in the first cell.

In the fourth aspect, after completion of a BFR procedure (BFR completion), a PUCCH/PUCCH resource for SR associated with a TRP in which beam failure is detected and a PUCCH/PUCCH resource for SR associated with a TRP in which no beam failure is detected may be updated based on q_new corresponding to a new candidate beam.

### (UE Capability Information)

In the first aspect to the fourth aspect above, following UE capabilities may be configured. Note that the following UE capabilities may each be interpreted as a parameter (for example, a higher layer parameter) configured for the UE by a network (for example, a base station).

UE capability information related to whether to support BFR in TRP units (for example, TRP specific BFR) may be defined.

UE capability information related to the number of BFD-RSs/BFD-RS sets possible to be supported by the UE for each BWP/for each cell/for each band/for each UE/in a cell group may be defined.

UE capability information related to the number of PUCCH resources for SR possible to be supported by the UE for each BWP/for each cell/for each band/for each UE/in a cell group may be defined.

UE capability information related to whether the UE supports association between a PUCCH resource for SR and a TRP index, association between a PUCCH resource for SR and a TCI state, or association between a PUCCH resource for SR and a BFD-RS/BFD-RS set may be defined.

UE capability information related to whether the UE supports configuration of a different association between a PUCCH resource for SR and a TRP index for each cell may be defined.

UE capability information related to whether to support a different BFR configuration for each cell (for example, cell #1: BFR in TRP units, cell #2: BFR in cell units) may be defined.

In this case, UE capability information related to whether to support a different number of BFD-RS sets for each cell (for example, cell #1: two BFD-RS sets, cell #2: one BFD-RS set) may be defined. UE capability information related to whether to support a different number of PUCCH resources for SR for each cell (for example, cell #1: two PUCCH resources for SR, cell #2: one PUCCH resource for SR) may be defined.

UE capability information related to whether to support update of a PUCCH/PUCCH resource for SR related to a TRP in which beam failure is detected/TRP in which no beam failure is detected, based on q_new after BFR completion may be defined.

The first aspect to the fourth aspect may be configured so that the UE supports/reports at least one of the above-described UE capabilities. Alternatively, the first aspect to the fourth aspect may be configured to be applied to a UE configured by a network.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

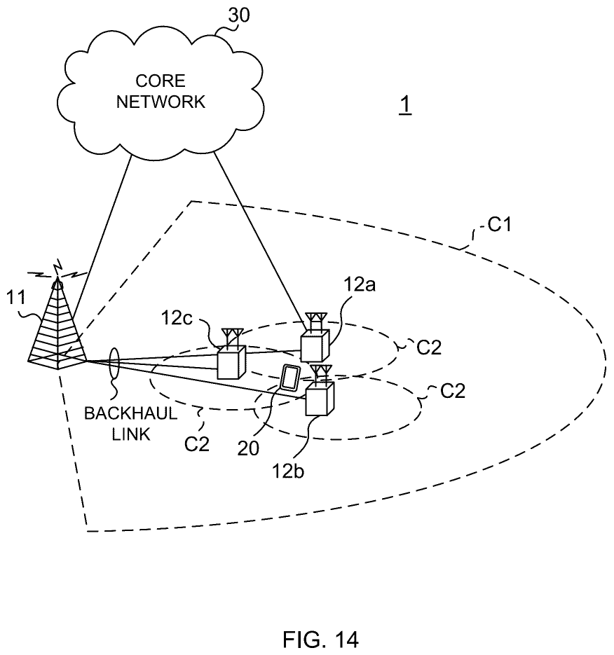

FIG. 14 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHZ), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a given search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

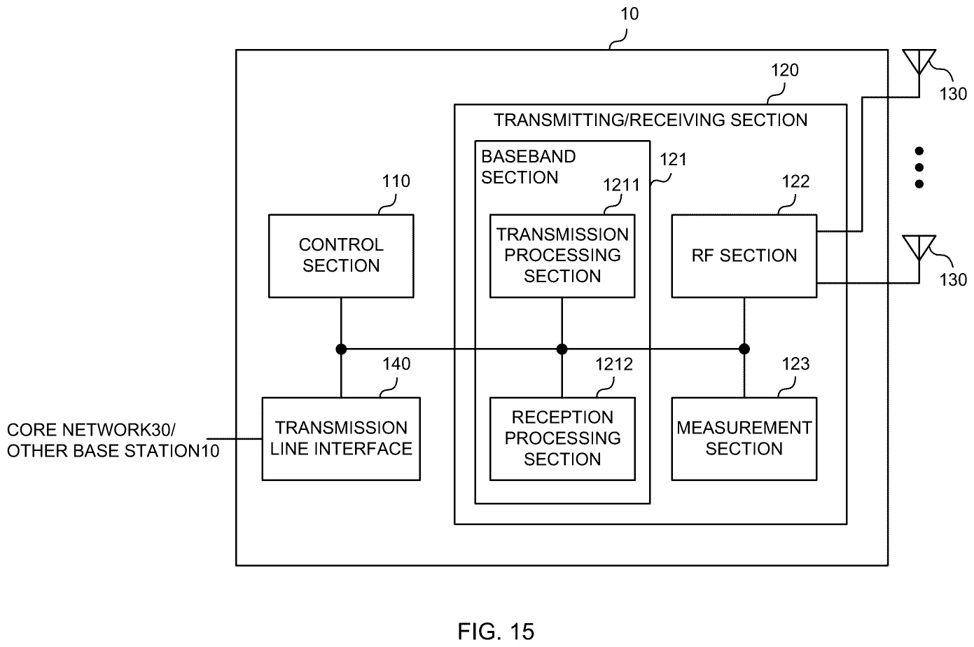

FIG. 15 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit information related to configuration of beam failure detection for each transmission/reception point (TRP) and information related to configuration of an uplink control channel resource corresponding to a scheduling request.

When a terminal detects beam failure in a first TRP, the control section 110 may control reception of the scheduling request transmitted from the terminal by using at least one of an uplink control channel resource corresponding to the first TRP and an uplink control channel resource corresponding to a second TRP different from the first TRP.

### (User Terminal)

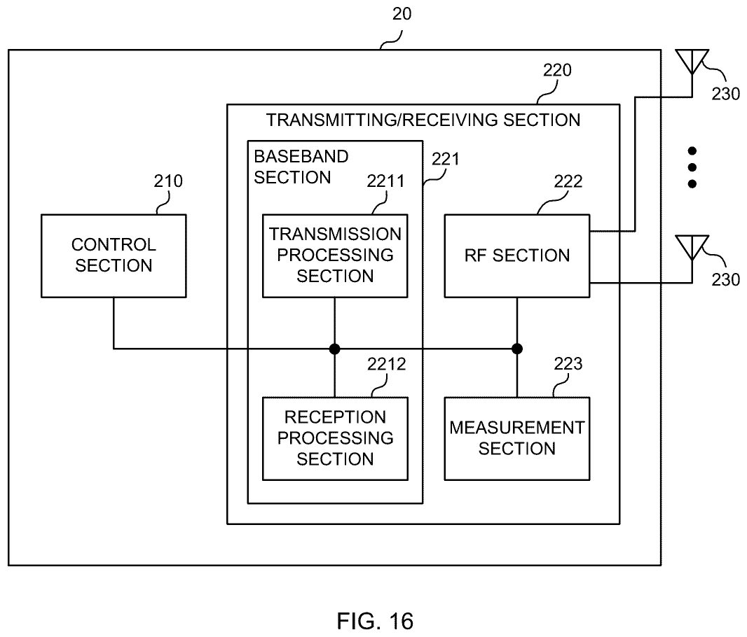

FIG. 16 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive information related to configuration of beam failure detection for each transmission/reception point (TRP) and information related to configuration of an uplink control channel resource corresponding to a scheduling request.

The transmitting/receiving section 220 may receive information related to association between an index of a TRP and an index of the uplink control channel resource corresponding to the scheduling request. The transmitting/receiving section 220 may receive information related to association between a TRP index and an index of configuration information of the scheduling request. The transmitting/receiving section 220 may receive information related to association between the TRP index and an index of a spatial relation of the uplink control channel resource corresponding to the scheduling request.

When beam failure is detected in a first TRP, the control section 210 may control transmission of the scheduling request by using at least one of an uplink control channel resource corresponding to the first TRP and an uplink control channel resource corresponding to a second TRP different from the first TRP.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

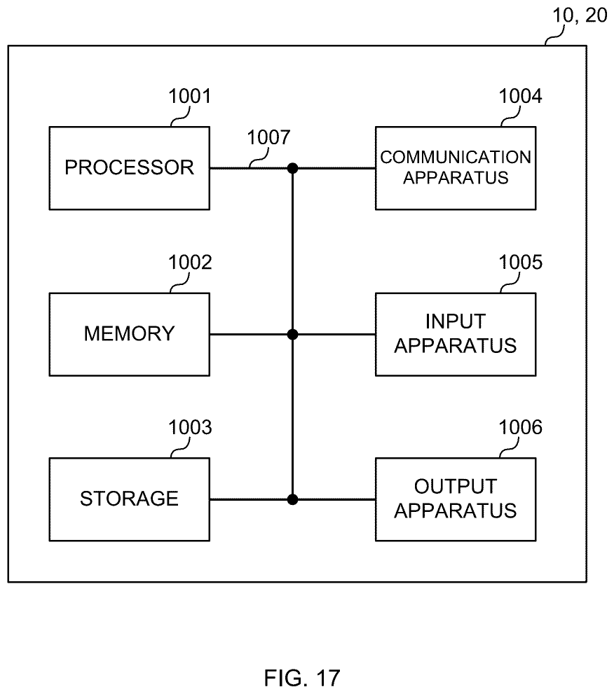

For example, a base station, a user terminal, and so on according to one embodiment of the present disclosure may function as a computer that executes the processes of the radio communication method of the present disclosure. FIG. 17 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIS.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for given numerology in a given carrier. Here, a common RB may be specified by an index of the RB based on the common reference point of the carrier. A PRB may be defined by a given BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be specified by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. MAC signaling may be notified by using media access control control element (MAC CE), for example.

Also, reporting of given information (for example, reporting of “X holds”) does not necessarily have to be reported explicitly, and can be reported implicitly (by, for example, not reporting this given information or reporting another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “reference signal (RS) port group,” a “layer,” the “number of layers,” a “rank,” a “resource,” a “resource set,” a “resource group,” a “beam,” a “beam width,” a “beam angular degree,” an “antenna,” an “antenna element,” a “panel,” a “transmission/reception point,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “sidelink (side)”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a transmitting section that transmits, when beam failure is detected in a transmission/reception point (TRP), a scheduling request by using another uplink control channel resource different from an uplink control channel resource associated with the TRP; and
a control section that performs control to update the uplink control channel resource associated with the TRP after a recovery procedure for the beam failure.

2. The terminal according to claim 1, wherein
when beam failure is detected in a TRP corresponding to a first cell, the control section determines at least one of a cell and a TRP in which the scheduling request is transmitted, based on presence of another TRP in which no beam failure is detected in the first cell.

3. The terminal according to claim 1, wherein
when beam failure is detected in a TRP corresponding to a first cell and the scheduling request is transmitted to a second cell, the control section performs control to use an uplink control channel resource associated with the first cell or the TRP corresponding to the first cell.

4. The terminal according to claim 1, wherein
the other uplink control channel resource is associated with a second TRP different from the first TRP or is not associated with any TRP.

5. A radio communication method for a terminal, the radio communication method comprising:
transmitting, when beam failure is detected in a transmission/reception point (TRP), a scheduling request by using another uplink control channel resource different from an uplink control channel resource associated with the TRP; and
performing control to update the uplink control channel resource associated with the TRP after a recovery procedure for the beam failure.

6. A base station comprising:
a receiving section that receives, when beam failure is detected in a transmission/reception point (TRP), a scheduling request transmitted by using another uplink control channel resource different from an uplink control channel resource associated with the TRP; and
a control section that performs control to update the uplink control channel resource associated with the TRP after a recovery procedure for the beam failure.

7. The terminal according to claim 2, wherein
the other uplink control channel resource is associated with a second TRP different from the first TRP or is not associated with any TRP.

8. The terminal according to claim 3, wherein
the other uplink control channel resource is associated with a second TRP different from the first TRP or is not associated with any TRP.
